(19) United States
(12) Patent Application Publication
(10) Pub. No.: US 2026/0000059 A1
(43) Pub. Date: Jan. 1, 2026

(54) FLOW CONTROL VALVE

(71) Applicants: Xiaopeng GAN, Leqing (CN); Huancong MA, Cixi (CN)

(72) Inventors: Xiaopeng GAN, Leqing (CN); Huancong MA, Cixi (CN)

(21) Appl. No.: 18/897,853

(22) Filed: Sep. 26, 2024

(30) Foreign Application Priority Data
Jul. 1, 2024 (CN) 202421544754.9

(51) Int. Cl. A01K 63/04; F16K 31/02; F16K 37/00

(52) U.S. Cl. CPC A01K 63/042; F16K 31/02; F16K 37/0058

(57) ABSTRACT

A flow control valve is provided, including: a valve body defining an inlet and an outlet, and including a transparent tube; and a control module including a control unit, a sensor assembly, a driving source and a valve core. The driving source cooperates with the valve core. The sensor assembly is located at an outer side of the transparent tube, and the sensor assembly is configured to detect a flow rate of bubbles. When the control unit monitors that the flow rate of the bubbles exceeds a threshold, the control unit controls the driving source to operate to make the valve core reduce a gas inflow at the inlet. When the control unit monitors that the flow rate of the bubbles is lower than threshold, the control unit controls the driving source to operate to make the valve core increase the gas inflow at the inlet.

### CROSS-REFERENCE TO RELATED APPLICATION

This application claims priority to Chinese Patent Application No. 202421544754.9, filed on Jul. 1, 2024, which is herein incorporated by reference in its entirety.

### TECHNICAL FIELD

The disclosure relates to the technical field of aquariums, and more particularly to a flow control valve.

### BACKGROUND

In the field of aquariums, vegetation inside a fish tank requires carbon dioxide as a raw material for photosynthesis. Those skilled in the art inject carbon dioxide gas into the fish tank to dissolve the carbon dioxide in water.

A traditional method to adjust a gas inflow of the carbon dioxide is through manual adjustment. However, when an input gas pressure is unstable (e.g., there is no constant pressure valve, or the constant pressure valve is faulty), a gas outflow is changed.

### SUMMARY

A technical problem to be solved of the disclosure is how to control a flow rate of carbon dioxide. Thus, the disclosure provides a flow control valve, including: a valve body and a control module.

The valve body defines an inlet and an outlet, and the valve body includes a transparent tube.

The control module includes: a control unit, a sensor assembly, a driving source and a valve core, and the driving source cooperates with the valve core.

The sensor assembly is located at an outer side of the transparent tube, and the sensor assembly is configured to detect a flow rate of bubbles. When the control unit monitors that the flow rate of the bubbles exceeds a threshold, the control unit is configured to control the driving source to operate, to make the valve core reduce a gas inflow at the inlet. When the control unit monitors that the flow rate of the bubbles is lower than threshold, the control unit is configured to control the driving source to operate, to make the valve core increase the gas inflow at the inlet.

The flow rate of the bubbles is detected to ensure accuracy of the detection of carbon dioxide, to thereby achieve an effect of stable flow control. Compared to a method of detecting gas pressure, this detection is more accuracy, no matter how the input gas pressure changes, the flow control valve will automatically calibrate the flow to a set flow rate.

In an embodiment, the control module defines an accommodating cavity, and the valve body is accommodated in the accommodating cavity.

Through setting the accommodating cavity, the control module is directly connected and fixed with the valve body, to thereby improve a connection effect.

In an embodiment, the sensor assembly defines a notch, and the transparent tube extends into the notch.

Through setting the notch, the sensor can detect the flow rate of the bubbles accurately. Meanwhile, an exposed part of the transparent tube is easy for an operator to observe and has the effect of dual use.

In an embodiment, the flow control valve further includes a valve seat, and the valve seat is in communication with the inlet. The valve core is configured to move to a connection between the valve seat and the inlet, the valve seat, or the inlet.

The valve seat is used to connect the valve body and a carbon dioxide cylinder, to thereby achieve a communication effect. The valve core can control the gas inflow at the inlet according to different situations, to thereby achieve the effect of stable control.

In an embodiment, the driving source is a motor or a coil.

The driving source can be a motor, and the motor is configured to directly cooperate with the valve core. Even if there is a power outage, it will not affect the position of the valve core. The setting of the coil can also achieve drive of the valve core, to obtain a control effect of the flow.

In an embodiment, the sensor assembly includes a photoelectric sensor or an infrared sensor.

The sensor can be set according to actual needs. Light from the sensor will refract when passing through the bubbles. At this time, a receiving end cannot receive the signal, thus a measurement can be performed to ensure the accuracy of the measurement. The output rate is adjusted through the control unit to ensure that the carbon dioxide is stably output during a whole cycle.

In an embodiment, the control module further includes a circuit board, and the control unit is disposed on the circuit board.

Through setting the circuit board, the effect of module connection is achieved, to make the installation more convenient.

In an embodiment, the control unit can be controlled by a BLUETOOTH, an application (APP), a local area network (LAN), or Internet of Things (IoT).

The BLUETOOTH, the APP, the LAN and the IoT each can achieve the control effect, and the operator can achieve the effect of rapid control through different ways.

### BRIEF DESCRIPTION OF DRAWINGS

In order to describe technical solutions in embodiments of the disclosure or in the related art clearly, drawings required in the embodiment or related art descriptions are simply introduced below. Apparently, the drawing in the following descriptions are some of the embodiments of the disclosure. For those skilled in the art, other drawings can be obtained according to the drawings without creative work.

FIG. 1 illustrates a schematic structural diagram of a flow control valve according to an embodiment of the disclosure.

FIG. 2 illustrates a section diagram of the flow control valve according to an embodiment of the disclosure.

FIG. 3 illustrates a section diagram of the flow control valve according to an embodiment of the disclosure.

FIG. 4 illustrates a schematic structural diagram of the flow control valve according to an embodiment of the disclosure.

### DETAILED DESCRIPTION OF EMBODIMENTS

The following will provide a clear and complete description of technical solutions of the disclosure in conjunction with drawings. Apparently, the described embodiments are some of the embodiments of the disclosure, not all of them. Based on the embodiments in the disclosure, all other embodiments obtained by those skilled in the art without creative work are within a scope of protection of the disclosure.

In the description of the disclosure, it should be noted that terms “center”, “up”, “down”, “left”, “right”, “vertical”, “horizontal”, “inside”, “outside” and other directional or positional relationships indicated are based on the directional or positional relationships shown in the drawings, only for the convenience of describing the disclosure and simplifying the description, and do not indicate or imply that a device or component referred to must have a specific orientation, be constructed and operated in a specific orientation, and therefore cannot be understood as limiting the disclosure. In addition, terms “first”, “second”, and “third” are only used for descriptive purposes and cannot be understood as indicating or implying relative importance.

In the description of the disclosure, it should be noted that unless otherwise specified and limited, terms “installation”, “connecting”, and “connection” should be broadly understood, for example, they can be a fixed connection, a detachable connection, or an integrated connection. It can be a mechanical connection or an electrical connection. It can be directly connected, indirectly connected through an intermediate medium, or connected internally between two components. For those skilled in the art, specific meanings of the above terms in the disclosure can be understood in specific situations.

In addition, the technical features involved in different embodiments of the disclosure described below can be combined with each other as long as they do not conflict with each other.

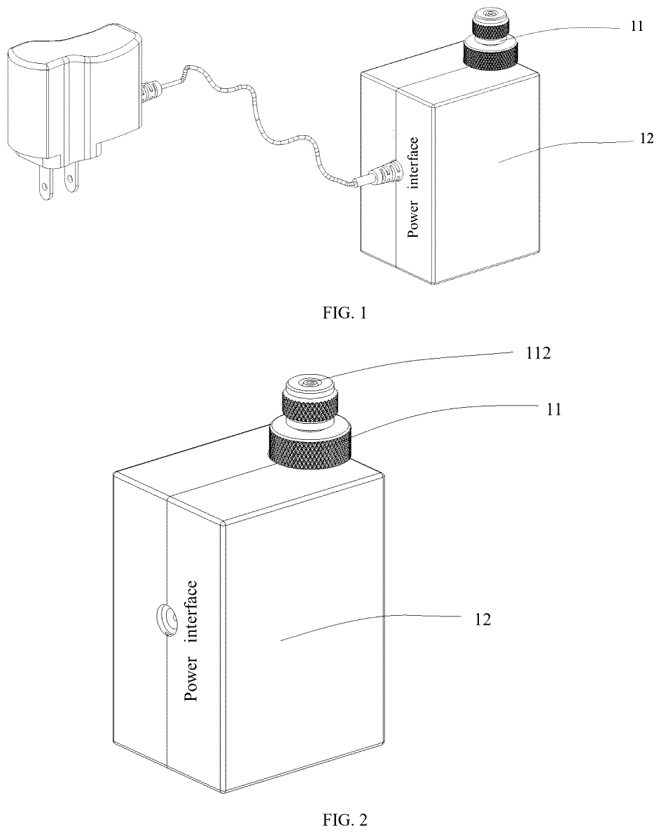

As shown in FIGS. 1-4, the embodiment provides a flow control valve, including: a valve body 11 and a control module 12.

The valve body 11 defines an inlet 111 and an outlet 112, and the valve body includes a transparent tube 113. Carbon dioxide gas enters into the valve body 11 from the inlet 111, passes through the transparent tube 113 and finally exits through the outlet 112 before being injected into a fish tank. It should be noted that an inside of the valve body 11 needs to be filled with liquid, when the bubbles enter the valve body 11, the bubbles float upwards due to effect of buoyancy. Thus, the inlet 111 is defined on a lower end of the valve body 11, and the outlet 112 is defined on an upper end of the valve body 11. It should be further noted that during using the flow control valve, the valve body 11 needs to be filled with liquid, otherwise bubbles cannot be generated. This is common knowledge, so the embodiment will not describe it further.

In an embodiment, the valve body 11 further includes a check valve 20, the check valve 20 is disposed above the inlet 111 of the valve body 11, and is configured to prevent gas reflux in the transparent tube 113.

The control module 12 includes: a control unit 19, a sensor assembly 13, a driving source 14 and a valve core 15, and the driving source 14 cooperates with the valve core 15. When the driving source 14 working, the valve core 15 also moves accordingly. The valve core 15 is used to control the gas inflow at the inlet 111, and the inlet 111 can be completely closed, with zero gas inflow at this time, or can be opened to the maximum.

In an exemplary embodiment, the control unit 19 can be a controller or a processor.

The sensor assembly 13 is located at an outer side of the transparent tube 113, and the sensor assembly 13 is configured to detect a flow rate of bubbles. This detection can be light detection, that is, under a normal condition, the transparent tube 113 is filled with liquid. An input end emits a beam of light, and an output end receives the beam of light. When a refraction problem of light is considered, those skilled in the art can control a position between the input end and the output end, thereby achieving an accurate detection effect. When the bubbles pass through the beam of light, refraction is occurred due to an effect of the bubbles. The output end cannot receive the beam of light, thus generating a signal. Due to a bottom-up movement of the bubbles, a flow rate of gas in the entire gas supply system is obtained through metering the flow rate of the bubbles, to keep the flow rate of the gas in the gas supply system in a stable state. When the control unit 19 monitors that the flow rate of the bubbles exceeds a threshold, the control unit 19 controls the driving source 14 to operate, to make the valve core 15 reduce a gas inflow at the inlet 111. When the control unit 19 monitors that the flow rate of the bubbles is lower than the threshold, the control unit 19 controls the driving source 14 to operate, to make the valve core 15 increase the gas inflow at the inlet 111. The threshold can be a numerical value or an interval, which can be adjusted by those skilled in the art according to actual needs. The flow rate of the bubbles is detected to ensure accuracy of the detection of carbon dioxide, to thereby achieve an effect of stable flow control. Compared to a method of detecting gas pressure, this detection is more accuracy, no matter how the input gas pressure changes, the flow control valve will automatically calibrate the flow to a set flow rate.

In an embodiment, the control module 12 defines an accommodating cavity 18, and the valve body 11 is accommodated in the accommodating cavity 18. Through setting the accommodating cavity 18, the control module is directly connected and fixed with the valve body, to thereby improve a connection effect. The control module 12 includes a shell, the shell defines the accommodating cavity 18, and other components of the control module 12 are accommodated in the accommodating cavity 18. In addition, the control module 12 can only have the cooperation between the sensor assembly 13 and the valve body 14, and the other components of the control module 12 are located outside the valve body 11.

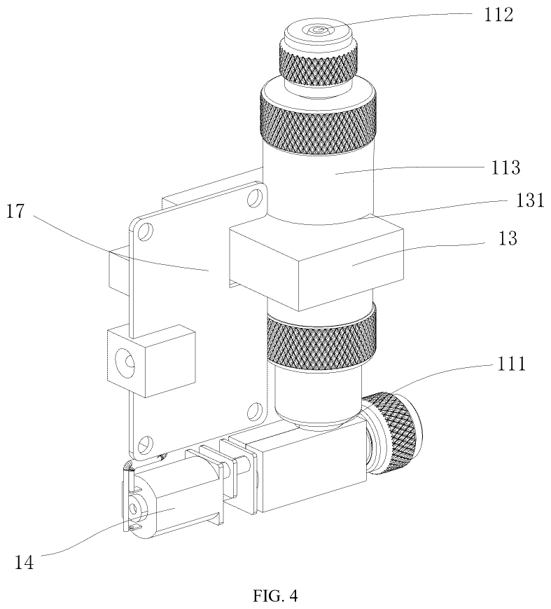

In an embodiment, as shown in FIG. 4, the sensor assembly 13 defines a notch 131, and the transparent tube 113 extends into the notch 131. Specifically, the transparent tube 113 can partially extend into the notch, or it can extend as a whole into the notch 131. Through setting the notch, the sensor can detect the flow rate of the bubbles accurately. Meanwhile, an exposed part of the transparent tube is easy for an operator to observe and has the effect of dual use. In the embodiment, the shell defines a through hole, and the through hole cooperates with the exposed part of the transparent tube 113. The notch 131 can be a U-shaped notch 131 to form a clamping like state.

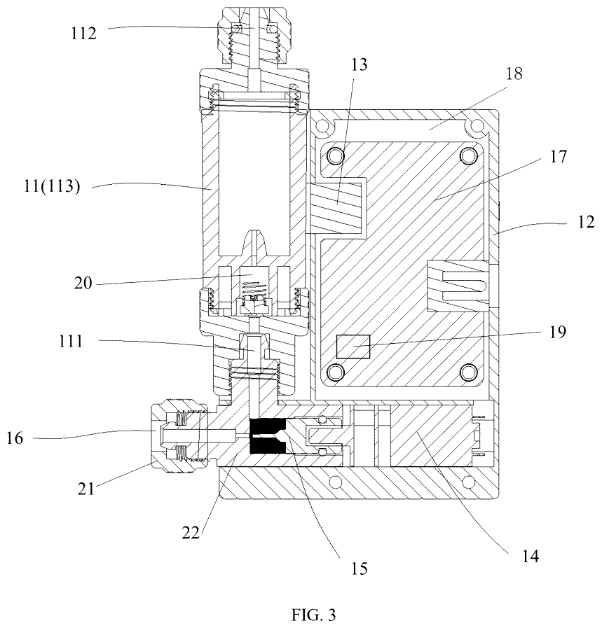

In an embodiment, as shown in FIG. 3, the flow control valve further includes a valve seat 16, and the valve seat 16 is in communication with the inlet 111. Specifically, an end of the valve seat 16 is in communication with a carbon dioxide cylinder, and the other end of the valve seat 16 is in communication with the inlet 111, to thereby achieve the overall gas supply effect. The pressure between the valve seat 16 and the carbon dioxide cylinder can also be adjusted through a pressure reducing valve. The valve core 15 can move to the connection between the valve seat 16 and the inlet 111, to thereby control the gas inflow at the inlet 111. The valve core 15 can also move to the valve seat 16, to control the flow at an outlet of the valve seat 16, to thereby control the gas inflow at the inlet 111. The valve core 15 can further move to the inlet 111, to close or open the inlet 111, to thereby control the gas inflow at the inlet 111. The valve seat 16 is used to connect the valve body 11 and the carbon dioxide cylinder, to achieve a communication effect. The valve core 15 can control the gas inflow at the inlet 111 according to different situations, to thereby achieve the stable control effect.

In an embodiment, the valve seat 16 includes a gas connector 21 and a valve seat body 22, and the gad connector 21 is threadedly connected to the valve seat body 22.

In an embodiment, the driving source 14 is a motor or a coil. The driving source 14 can be a motor, and the motor is configured to directly cooperate with the valve core 15. Even if there is a power outage, it will not affect the position of the valve core 15. The setting of the coil can also achieve drive of the valve core 15, to obtain a control effect of the flow.

In an embodiment, the sensor assembly 13 is a photoelectric sensor or an infrared sensor. The sensor can be set according to actual needs. Light from the sensor will refract when passing through the bubbles. At this time, a receiving end cannot receive the signal, thus a measurement can be performed to ensure the accuracy of the measurement. The output rate is adjusted through the control unit 19 to ensure that the carbon dioxide is stably output during a whole cycle. The sensor assembly 13 is located in the accommodating cavity 18.

In an embodiment, as shown in FIGS. 3-4, the control module 12 further includes a circuit board 17, and the control unit 19 is disposed on the circuit board 17. Through setting the circuit board 17, the effect of module connection is achieved, to make the installation more convenient. The circuit board 17 is located in the accommodating cavity 18. An external power supply of the control module 12 can be DC12V or AC220V.

In an embodiment, the control unit 19 can be controlled by a BLUETOOTH, an APP, a LAN, or an IoT. The BLUETOOTH, the APP, the LAN and the IoT each can achieve the control effect, and the operator can achieve the effect of rapid control through different ways.

Apparently, the above embodiments are only examples provided for clear illustration, and not limitations on the embodiments. For those skilled in the art, other forms of changes or amendments can be made based on the above descriptions. It is not necessary and impossible to exhaustively list all embodiments here. And the obvious changes or variations arising from this are still within the scope of protection created by the disclosure.

What is claimed is:

1. A flow control valve, comprising:
a valve body, defining an inlet and an outlet, wherein the valve body comprises a transparent tube; and
a control module, comprising: a control unit, a sensor assembly, a driving source and a valve core; wherein the driving source cooperates with the valve core; and
wherein the sensor assembly is located at an outer side of the transparent tube, and the sensor assembly is configured to detect a flow rate of bubbles; when the control unit monitors that the flow rate of the bubbles exceeds a threshold, the control unit is configured to control the driving source to operate, to make the valve core reduce a gas inflow at the inlet; when the control unit monitors that the flow rate of the bubbles is lower than the threshold, the control unit is configured to control the driving source to operate, to make the valve core increase the gas inflow at the inlet.

2. The flow control valve as claimed in claim 1, wherein the control module defines an accommodating cavity, and the valve body is accommodated in the accommodating cavity.

3. The flow control valve as claimed in claim 1, wherein the sensor assembly defines a notch, and the transparent tube extends into the notch.

4. The flow control valve as claimed in claim 1, further comprising: a valve seat; wherein the valve seat is in communication with the inlet, and the valve core is configured to move to a connection between the valve seat and the inlet, the valve seat, or the inlet.

5. The flow control valve as claimed in claim 1, wherein the driving source is a motor or a coil.

6. The flow control valve as claimed in claim 1, wherein the sensor assembly is a photoelectric sensor or an infrared sensor.

7. The flow control valve as claimed in claim 1, wherein the control module further comprises: a circuit board, and the control unit is disposed on the circuit board.

8. The flow control valve as claimed in claim 5, wherein the control unit is configured to be controlled by a BLUETOOTH, an application (APP), a local area network (LAN), or Internet of Things.

9. A flow control valve, comprising:
a valve body, defining an inlet and an outlet; wherein the valve body is provided with a transparent tube connected between the inlet and the outlet;
a control module, comprising:
a control unit;
a sensor assembly, located at an outer side of the transparent tube;
a valve core, disposed on a lower end of the valve body, and in communication with the inlet of the valve body; and
a driving source, disposed on a side of the valve core; wherein the driving source is configured to drive the valve core to move to control gas inflow at the inlet; and
wherein the sensor assembly is configured to detect a flow rate of bubbles in the transparent tube, and transmit the detected flow rate of the bubbles to the control unit; and the control unit is configured to control the driving source to move the valve core to reduce the gas inflow at the inlet in response to the detected flow rate of the bubbles being greater than a threshold, and to control the driving source to move the valve core to increase the gas inflow at the inlet in response to the detected flow rate of the bubbles being lower than the threshold.
